(19) United States
(12) Patent Application Publication
(10) Pub. No.: US 2017/0350663 A1
(43) Pub. Date: Dec. 7, 2017

(54) COMPOSITE MATERIAL FOR PASSIVE RADIATIVE COOLING

(71) Applicant: PC Krause and Associates, Inc., West Lafayette, IN (US)

(72) Inventor: Alex Heltzel, Austin, TX (US)

(21) Appl. No.: 15/684,688

(22) Filed: Aug. 23, 2017

Related U.S. Application Data
(63) Continuation-in-part of application No. 15/172,304, filed on Jun. 3, 2016.
(60) Provisional application No. 62/170,369, filed on Jun. 3, 2015.

(51) Int. Cl. F28F 13/18; E04B 1/76; B05D 1/02; E04D 7/00

(52) U.S. Cl. CPC F28F 13/185; E04D 7/00; E04B 1/76; B05D 1/02; E04B 2001/7691; F28F 2245/06; F28F 2275/02

(57) ABSTRACT

A composite material for passive radiative cooling including a base layer, and at least one emissive layer located adjacent to a surface of the base layer, wherein the at least one emissive layer is affixed to the surface of the base layer via a binding agent. Also disclosed are methods of applying passive coolers to articles and surfaces to be adapted for passive radiative cooling.

### RELATED APPLICATION DATA

This application is a continuation-in-part of U.S. application Ser. No. 15/172,304, filed Jun. 3, 2016, which claims the priority benefit of U.S. application Ser. No. 62/170,369, filed Jun. 3, 2015, which are hereby incorporated in their entirety herein by reference.

### TECHNICAL FIELD

The present disclosure relates to passive coolers which are capable of cooling a supported article by radiation to the surrounding environment; and more particularly to a composite material for passive radiative cooling, and methods of applying passive coolers to articles and surfaces to be adapted for passive radiative cooling.

### BACKGROUND

Radiative cooling refers to the process whereby a body will emit as radiation heat energy absorbed through normal convection and conduction processes. Generally, there is a low absorption “atmospheric window” in the region of 8-13 μm where the atmosphere is relatively transparent. A similar window exists for some wavelengths within the 1-5 μm band. Radiation from the Earth's surface within these wavelengths is likely to pass through these atmospheric windows to space rather than be absorbed by the atmosphere and returned to the Earth's surface.

For the wavelengths having high atmospheric absorption there will be significant amounts of radiation in the atmosphere as that radiation is absorbed and re-emitted back to Earth. Conversely, for the wavelengths corresponding to these atmospheric windows there will be little radiation in the atmosphere as the majority of radiation emitted by the Earth at these wavelengths is allowed to pass through the atmosphere to space.

A “selective surface” is one that exploits the atmospheric window by preferentially emitting thermal energy at wavelengths corresponding to these atmospheric windows where there is reduced incident radiation which may be absorbed by the surface, that allows rapid transfer of that radiation to space, and by that is non-absorptive of radiation outside these wavelengths.

Radiative cooling can include nighttime cooling; however, such cooling often has a relatively limited practical relevance. For instance, nighttime radiative cooling is often of limited value because nighttime has lower ambient temperatures than daytime, and therefore, there is less of a need for cooling. There is therefore a need for improvements in composite materials to passively cool terrestrial structures such as buildings, homes, electronics and other objects in both the daytime and the nighttime.

### SUMMARY

In some embodiments, a composite material for passive radiative cooling is provided. In some embodiments, the composite material comprises a base layer and at least one thermally-emissive layer located adjacent to a surface of the base layer. In some embodiments, the at least one emissive layer is affixed to the surface of the base layer via a binding agent.

In some embodiments, a composite material for passive radiative cooling is provided. In some embodiments, the composite material comprises a base layer and at least one thermally-emissive layer located adjacent to a surface of the base layer. In some embodiments, the surface of the base layer comprises a reflective substrate comprising an adhesive layer. In some embodiments, the at least one emissive layer is affixed to the base layer via the adhesive layer of the base layer.

Other embodiments are also disclosed.

The present invention also includes embodiments in the form of a liquid suspension composition adapted to form a passive radiative cooling coating on a surface, the composition comprising a liquid suspension of microparticles in a liquid binding agent, the binding agent adapted to be disposed upon a surface and cured so as to form a thermally-emissive layer on the surface, whereby the thermally-emissive layer is affixed to the surface via the binding agent.

Some variations of the liquid suspension may include a binding agent that is composed of a polymer material, and in some embodiments the binding agent may be transparent.

In some embodiments of the liquid suspension, the microparticles may be composed of silica material.

The microparticles in some embodiments may be of a characteristic dimension between about 5 to about 50 μm, while other embodiments feature microparticles of a characteristic dimension less than or equal to 30 μm.

As but one example embodiment, the liquid suspension composition may comprise a liquid suspension of a microparticles composed of silica material having a characteristic dimension between about 5 to about 50 μm in a liquid binding agent composed of a transparent polymer material, the binding agent adapted to be disposed upon a surface and cured so as to form a thermally-emissive layer on the surface, whereby the thermally-emissive layer is affixed to the surface via the binding agent.

For the purpose of application, the liquid suspension may be of a viscosity suitable for application to the desired surface and may depend upon such factors as the nature and angle of the surface to which the liquid suspension is to be applied for the formation of a thermally-emissive layer, as well as the respective cure time. Application may be made through the use of brushes, squeegee or similar device adapted to accept a loading of the liquid suspension for application to the desired surface. This may be apparent to one of ordinary skill as the liquid suspension is formed and may depend upon the viscosity of the liquid binding agent and the microparticle loading in the liquid suspension.

In some embodiments, the viscosity of the liquid suspension may be sufficiently diminished to permit the liquid suspension to be applied to a surface in the form of a spray. The viscosity may be adjusted depending upon the nature of the sprayer to be used and may depend upon such factors as the sprayer pressure and sprayer orifice, ancillary factors such as ambient temperature, humidity and movement of the surrounding atmosphere, as well as the nature and angle of the surface to which the liquid suspension is to be applied for the formation of a thermally-emissive layer, as well as the cure time of the binding agent.

Other embodiments include methods of applying passive coolers to articles and surfaces to be adapted for passive radiative cooling. Such methods include those generally characterized as involving the following general steps: (1) depositing (optionally spraying) a liquid mixture of microspheres and binder onto the article or surface to be adapted for passive radiative cooling, and (2) allowing the mixture to cure so as to form an emissive layer on the article or surface. In other embodiments, the method includes the following general steps: (1) applying a base layer onto an article or surface to be adapted for passive cooling so as to form a base layer surface, (2) depositing (optionally spraying) a liquid mixture of microspheres and binder onto the base layer surface, and (3) allowing the mixture to cure so as to form an emissive layer on the base layer surface.

Some embodiments may be generally described as a method of providing a composite material for passive radiative cooling to a surface, the method comprising: (1) obtaining access to an object to be cooled through passive radiative cooling, the object having a surface; (2) applying to the surface a liquid suspension of microparticles in a liquid binding agent; and (3) curing the binding agent so as to form a thermally-emissive layer on the surface, whereby the thermally-emissive layer is affixed to the surface via the binding agent.

The liquid suspension may be applied in any form that may be effective for the chosen application and may be applied in the form of a spray.

The object may comprise a base layer to which the liquid suspension is applied, and wherein the base layer comprises a reflective substrate. The reflective substrate in some embodiments may be composed of at least one of aluminum, silver, glass, polyurethane, nylon, and polyethylene fibers. The reflective substrate in some embodiments may comprise paint.

The binding agent may be composed of a polymer material and in some embodiments may be transparent. The binding agent in some embodiments may have a characteristic thickness less than or equal to approximately 50 μm.

The emissive layer(s) in some embodiments may be composed of silica material, and in some embodiments may comprise a plurality of microparticles. The plurality of microparticles may be composed of silica material, and may include a characteristic dimension between about 5 to about 50 μm, and may generally have a characteristic dimension less than or equal to 30 μm.

In other embodiments, the method of providing a composite material for passive radiative cooling may include the provision of a base layer, which embodiments may be generally described as a method comprising: (1) obtaining access to an object to be cooled through passive radiative cooling, the object having a base layer; (2) applying to the base layer a liquid suspension of microparticles in a liquid binding agent to the base layer, and (3) curing the binding agent so as to form at least one thermally-emissive layer located adjacent to a surface of the base layer, wherein the surface of the base layer comprises a reflective substrate comprising an adhesive layer, and wherein the at least one emissive layer is affixed to the base layer via the adhesive layer of the base layer. The liquid suspension, base layer/reflective substrate, binding agent and microparticles for these embodiments may be as described above.

In still other embodiments, the method may include the following general steps: (1) applying microspheres bearing a binder coating onto an article or surface to be adapted for passive radiative cooling, and (2) curing the binder coating so as to form an emissive layer on the article or surface. Yet another embodiment includes the steps of: (1) applying a base layer onto an article or surface to be adapted for passive cooling so as to form a base layer surface, (2) applying microspheres bearing a binder coating onto the base layer surface, and (3) curing the binder coating so as to form an emissive layer on the base layer surface.

Still other embodiments may be generally described as a method of providing a composite material for passive radiative cooling to a surface, the method comprising: (1) obtaining access to an object to be cooled through passive radiative cooling, the object having a surface; (2) applying to the surface a plurality of microparticles having a coating of a binding agent to the surface; and (3) curing the binding agent so as to form at least one thermally-emissive layer on the surface, whereby the thermally-emissive layer is affixed to the surface via the binding agent. In some embodiments the object may comprise a base layer to which the microparticles are applied. The base layer/reflective substrate, binding agent and microparticles for these embodiments may be as described above may be as described above.

Yet other embodiments may be generally described as a method of providing a composite material for passive radiative cooling to a surface, the method comprising: (1) obtaining access to an object to be cooled through passive radiative cooling, the object having a base layer; (2) applying to the base layer a plurality of microparticles having a coating of a binding agent to the surface; and (3) curing the binding agent so as to form at least one thermally-emissive layer located adjacent to a surface of the base layer, wherein the surface of the base layer comprises a reflective substrate comprising an adhesive layer, and wherein the at least one emissive layer is affixed to the base layer via the adhesive layer of the base layer. The base layer/reflective substrate, binding agent and microparticles for these embodiments may be as described above may be as described above.

Further embodiments may be generally described as an industrial or building surface, such as a roofing surface bearing composite material for passive radiative cooling comprising: (1) a roofing surface; and (2) at least one thermally-emissive layer located adjacent to the roofing surface, wherein the at least one emissive layer is affixed to the roofing surface via a binding agent. The roofing surface may comprises a base layer to which the liquid suspension is applied, and wherein the base layer comprising a reflective substrate. The base layer/reflective substrate, binding agent and microparticles for these embodiments may be as described above may be as described above. As to the embodiments involving roofing surfaces, these may comprise asphalt, wood or synthetic shingles, tiles or other metal or composite roofing material surfaces that may serve as the base layer as described herein.

Other embodiments include a method of providing a composite material for passive radiative cooling to a roof surface, the method comprising: (1) applying to the roof surface a liquid suspension of microparticles in a liquid binding agent and (2) curing the binding agent so as to form a thermally-emissive layer on the roof surface, whereby the thermally-emissive layer is affixed to the roof surface via the binding agent. The roofing surface may comprises a base layer to which the liquid suspension is applied, and the base layer/reflective substrate (if present), binding agent and microparticles for these embodiments may be as described above may be as described above.

### BRIEF DESCRIPTION OF DRAWINGS

FIG. 1 illustrates a schematic cross-sectional view of a composite material for passive radiative cooling according to one embodiment of the present disclosure;

FIG. 2 illustrates a cross-sectional view of a microparticle according to one embodiment of the present disclosure;

FIG. 3 illustrates a graph of a cooling potential of composite materials against ambient daytime temperatures;

FIG. 4 illustrates a graph of a cooling potential of composite materials against ambient nighttime temperatures;

FIG. 5 illustrates a schematic cross-sectional view of a roof surface bearing a composite material for passive radiative cooling according to another embodiment of the present disclosure; and

FIG. 6 illustrates a schematic cross-sectional view of a roof surface bearing a composite material for passive radiative cooling according to still another embodiment of the present disclosure.

FIG. 7 is a stylized representation of a layer of a composite material for passive radiative cooling according to one embodiment of the present disclosure.

### DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

To enhance the emissivity in the 8-13 μm wavelength range or in the wavelength range supported by a blackbody with temperatures in the range of 250-350° K, a composite material, generally indicated at 10 is applied to the surface of an object. This leads to the preferential emission of light in the 8-13 μm range or in the wavelength range supported by a blackbody with temperatures in the range of 250-350° K. The preferential emission of light is embodied in the emissivity spectrum.

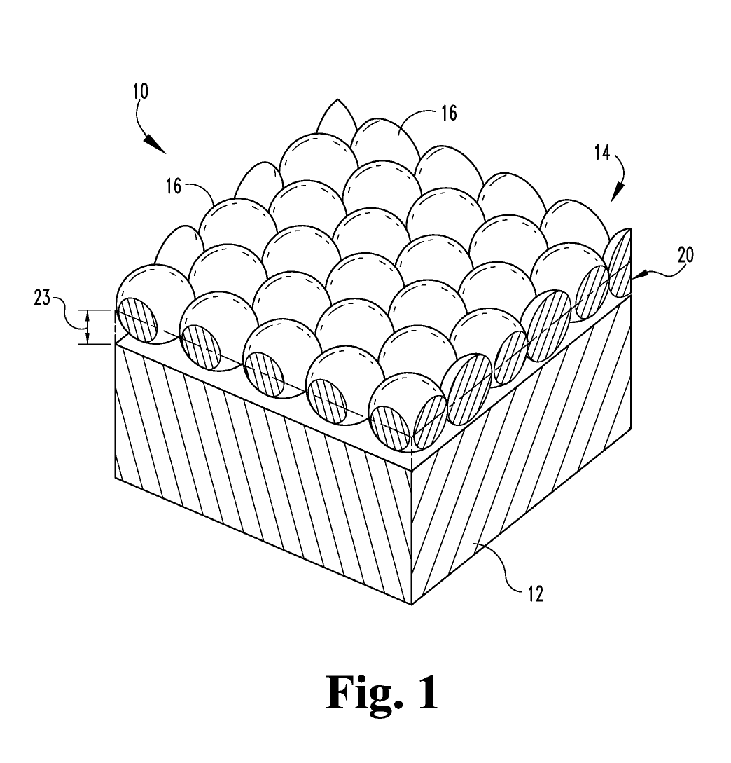

In some embodiments, the composite material 10, as shown in FIG. 1, includes a base layer 12 composed of a reflective substrate composed of at least one of aluminum, silver, glass, polyurethane, nylon, and polyethylene fibers. In some embodiments, the reflective substrate comprises paint. In some embodiments, the paint comprises white paint. In some embodiments, the reflective substrate comprises glue. The base layer 12 may be placed in thermal contact with an object to be cooled.

Immediately above the base layer 12 is at least one emissive layer 14 in some embodiments. The at least one emissive layer 14 may be arranged in a hexagonal monolayer, square monolayer, irregular monolayer, or irregular combination of between one and ten layers; exposed to sunlight and also to the atmosphere and paths for radiating thermal energy. In an embodiment, the at least one emissive layer 14 is composed of a plurality of microparticles 16. In one embodiment, each of the plurality of microparticles 16 may be formed in a geometric shape, and composed of a silica material. For example, the at least one emissive layer 14 may include a plurality of microspheres. The plurality of microparticles 16 may also be formed in square, cylindrical, or an irregular geometric shape to name a few non-limiting examples.

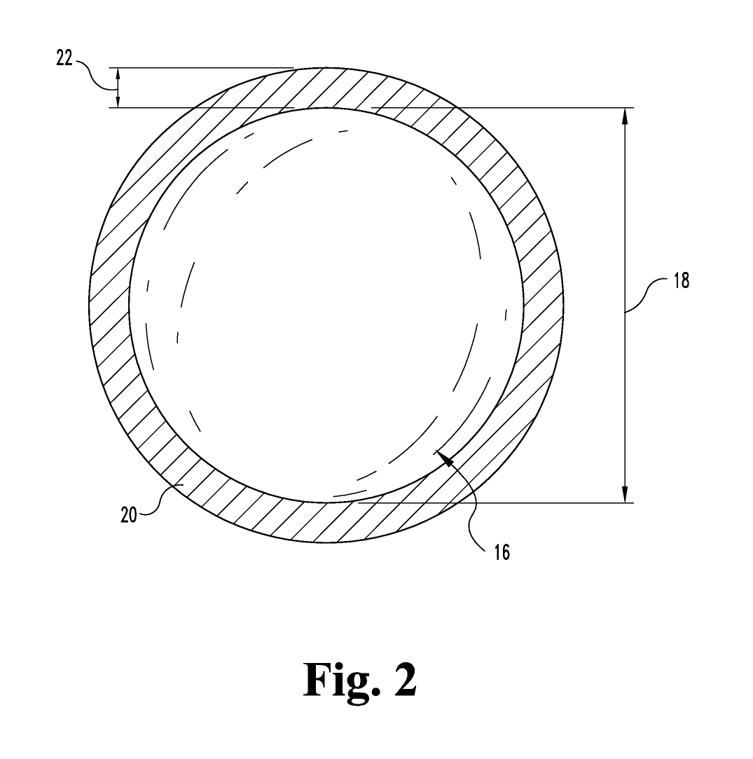

In an embodiment, with reference to FIG. 2, each of the plurality of microparticles 16 includes a characteristic dimension 18. In one embodiment, the characteristic dimension 18 is between about 5 to about 50 microns. In another embodiment, the characteristic dimension 18 is less than 30 microns. In still another embodiment, the characteristic dimension 18 is between about 10 and about 20 microns.

In an embodiment, with reference to FIGS. 1 and 2, the at least one emissive layer 14 is bonded to the base later 12 via a binding agent 20. The binding agent 20 may be composed of a transparent, polymer material. In some embodiments, the binding agent 20 may be uniformly applied to the at least one emissive layer 14 or applied to each of the plurality of microparticles 16, as shown in FIG. 2, via an electromagnetic brush (EMB) process or other suitable process. In some embodiments, the EMB process of the present disclosure utilizes a rotating wire brush in conjunction with static electromagnetic fields to deposit the plurality of microparticles 16 to the base layer 12. In some embodiments, the EMB process requires the use of the binding agent 20 coating each of the plurality of microparticles 16 to achieve adhesion under subsequent heating. When applied to each of the plurality of microparticles 16 via an electromagnetic brush (EMB) process, the binding agent 20 may have a characteristic thickness 22 between about 1 and about 50 microns in one embodiment. The binding agent 20 is melted after application of the plurality of microparticles 16 to the emissive layer 14 to form the binding agent 20 layer illustrated in FIG. 1.

In some embodiments, the polymer binder may be in the form of a polyacrylic base, such as those sold commercially under the MINWAX® trademark.

In one embodiment, a liquid suspension of silica microspheres may be sprayed and cured to create the emissive layer. This liquid will contain the polymer that, after spray deposition, cures to form a film containing the microspheres, the film in some embodiments the film resembling a dried, glue-like layer. Referring to FIG. 1, this Figure may be viewed as an application to an article or surface (with or without an intervening base layer 12) onto which a liquid suspension of silica microspheres 16 may be sprayed so as to be cured to form a cured binding agent 20 so as to form the emissive layer 14 on the article or surface as desired. Accordingly, this embodiment also includes the described deposition method of creating the described film structure.

In one such embodiment, the liquid suspension of silica microspheres may be sprayed and cured to create the emissive layer on an article or surface to be adapted for passive cooling, such as a building surface or roof surface. In such an embodiment, again referring to FIG. 1 analogously, this Figure may be viewed as an application to a building surface or roof surface (with or without an intervening base layer 12) onto which a liquid suspension of silica microspheres 16 may be sprayed so as to be cured to form a cured binding agent 20 so as to form the emissive layer 14 on the article or surface as desired. In such an embodiment, an existing roof surface may be considered a reflective surface as described herein onto which the liquid suspension of silica microspheres 16 may be sprayed so as to be cured to form a cured binding agent 20 so as to form the emissive layer 14 on the roof surface.

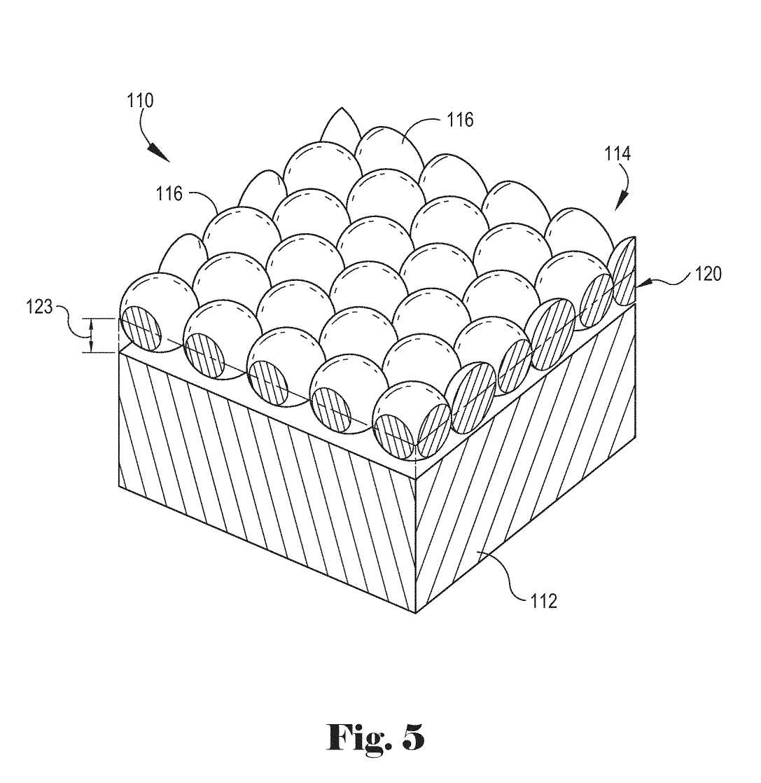

FIG. 5 shows an example of such an embodiment showing an application to a building surface or roof surface bearing a composite coating 110 (without an intervening base layer) formed by a liquid suspension of silica micro spheres 116 being sprayed so as to be cured to form a cured binding agent 120 so as to form the emissive layer 114 on the roofing surface 112. In such an embodiment, an existing roof surface may be considered a reflective surface as described herein onto which the liquid suspension of silica micro spheres 116 may be sprayed so as to be cured to form a cured binding agent 120 so as to form the emissive layer 114 on the roof surface, the characteristic thickness 123 of the binding agent 120 between about 1 and about 50 microns in one embodiment.

In another embodiment, the liquid suspension of silica microspheres may be sprayed and cured to create the emissive layer on an article or surface to be adapted for passive cooling, such as a building surface or roof surface. In such an embodiment, again referring to FIG. 1 analogously, this Figure may be viewed as an application to a building surface or roof surface (with or without an intervening base layer 12, or alternatively wherein the building surface or roof surface serves as the base layer) onto which a liquid suspension of silica microspheres 16 may be sprayed so as to be cured to form a cured binding agent 20 so as to form the emissive layer 14 on the article or surface as desired. In such an embodiment, an existing roof surface may be considered a reflective surface as described herein onto which the liquid suspension of silica microspheres 16 may be sprayed so as to be cured to form a cured binding agent 20 so as to form the emissive layer 14 on the roof surface. Thus, an embodiment of the invention is a composite material for passive radiative cooling may include a base layer (such as a building surface or roof surface), and at least one emissive layer located adjacent to a surface of the base layer, wherein the at least one emissive layer is affixed to the surface of the base layer via a binding agent.

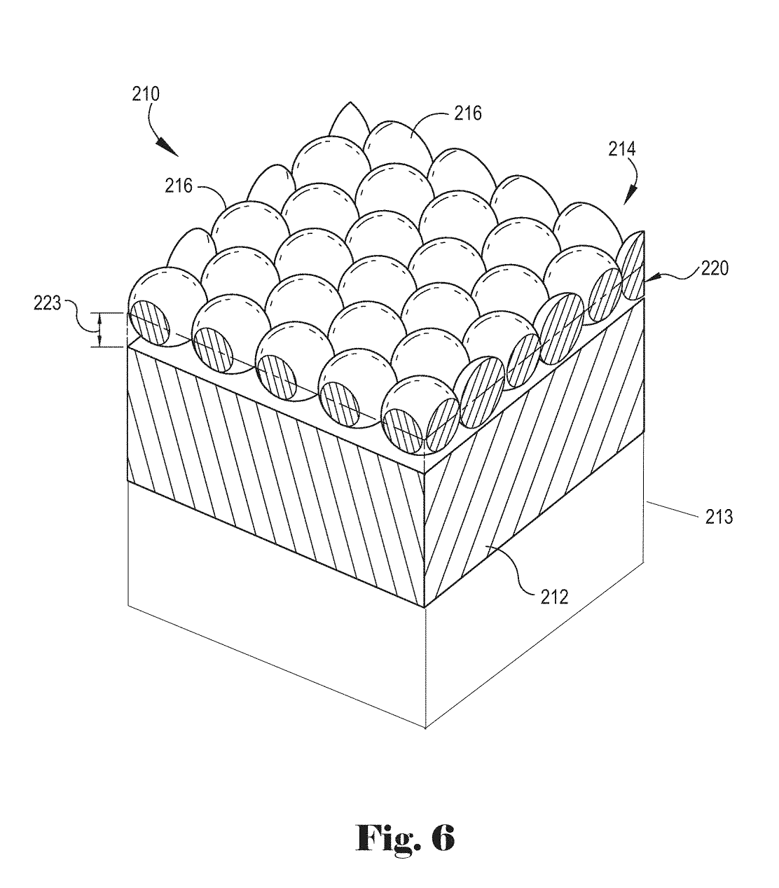

One such embodiment is shown in FIG. 6 showing an application to a roof surface 213 (with an intervening base layer 212) to form a roof surface bearing a composite coating 210 formed by a liquid suspension of silica microspheres 216 sprayed so as to be cured to form a cured binding agent 220 so as to form the emissive layer 214 on the roof surface 213. In such an embodiment, the intervening base layer 212 may be considered a reflective surface as described herein onto which the liquid suspension of silica microspheres 216 may be sprayed so as to be cured to form a cured binding agent 220 so as to form the emissive layer 214 on the roof surface. Thus, an embodiment of the invention is a composite material for passive radiative cooling may include a base layer (such as a building surface or roof surface), and at least one emissive layer located adjacent to a surface of the base layer, wherein the at least one emissive layer is affixed to the surface of the base layer via a binding agent having a characteristic thickness 223 of the binding agent 220 between about 1 and about 50 microns in one embodiment.

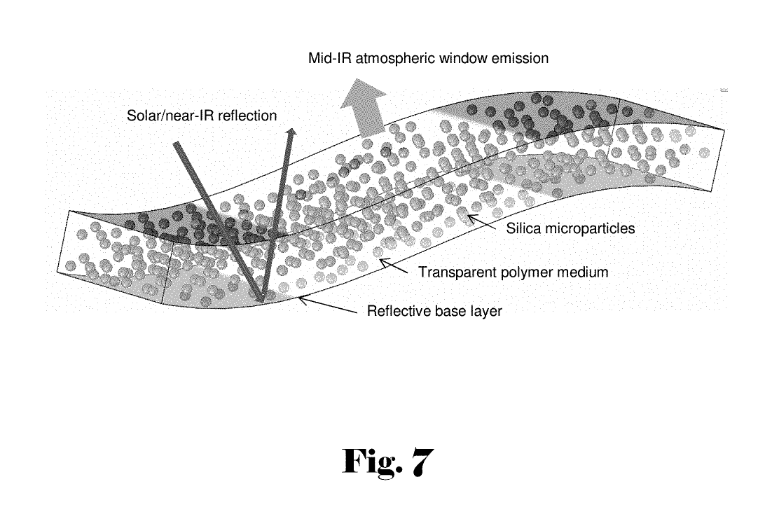

FIG. 7 is a stylized representation of a layer of a composite material for passive radiative cooling according to one embodiment of the present disclosure. FIG. 7 shows one embodiment of the composite material for passive radiative cooling that include an emissive layer that may include up to approximately ten layers of irregular spaced silica particles embedded in a polymer medium, with a reflective base layer, though more layers may be incorporated as may be beneficial to a given application. The reflective base layer reflects a majority of solar energy, which is transmitted through the transparent emissive layer. The emissive layer emits radiation in the infrared radiation band including the 8-13 micron atmospheric window.

Other embodiments include the application of passive cooling compositions to fabrics and garments, and the fabrics and garments so treated. These embodiments include the application of a liquid suspension of silica microspheres 16 may be sprayed so as to be cured to form a cured binding agent 20 so as to form the emissive layer 14 on the fabric and garment as desired.

In some embodiments, a dry dusting process, rather than the EMB process, is utilized by dry dusting the plurality of microparticles 16 over the base layer 12. The dry dusting process achieves a rough approximation of the uniform thin layer using a standard powder duster or squeeze bottle filled with the plurality of microparticles 16. In some embodiments, the dry dusting process is used with the binding agent 20 coating each of the plurality of microparticles 16 to achieve adhesion under subsequent heating. In some embodiments, the dry dusting process is used when the surface of base layer 12 comprises a reflective substrate comprising an adhesive layer that will dry, creating an adhesion and surface morphology. In some embodiments, the reflective substrate is glue or paint, to name a couple of non-limiting examples. It is envisioned that any suitable reflective substrate may be employed in the dry dusting process utilized in accordance with the embodiments of the present disclosure. In some embodiments, when base layer 12 comprising an adhesive layer is utilized in the dry dusting process, use of binding agent 20 is optional.

In some embodiments, wet printing and fusing is utilized in lieu of the EMB process and dry dusting process. In some embodiments, the wet printing and fusing process uses a printer to print a liquid suspension of the plurality of microparticles 16 directly on the base layer 12. In some embodiments, the wet printing and fusing process requires subsequent heating through infrared heating or a hot roller process to cure the binding agent 20 coating each of the plurality of microparticles 16 to achieve adhesion.

In one embodiment, the binding agent 20 layer shown in FIG. 1 includes a characteristic thickness 23 between about 1 and about 50 microns in one embodiment. It will be appreciated that the characteristic thickness 23 may be greater than approximately 50 μm in other embodiments. It will further be appreciated that when the characteristic thickness 22 is larger than the characteristic dimension 18 of the plurality of microparticles 16, a smooth surface morphology is created. Additionally, a rough surface morphology is created when the characteristic thickness 23 is less than the characteristic dimension 18 of the plurality of microparticles 16.

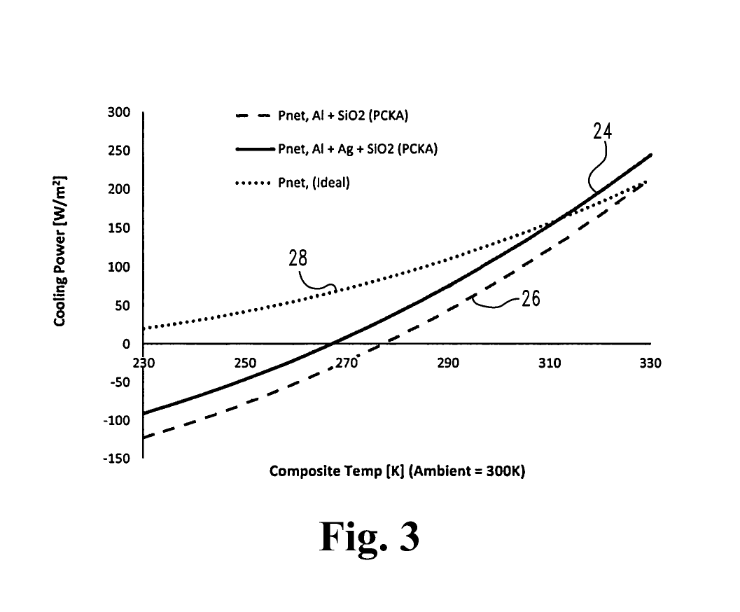

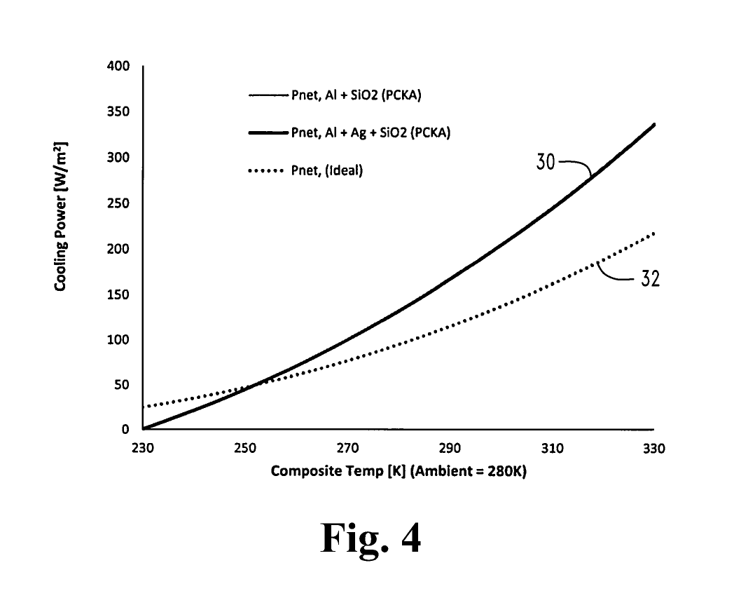

As shown in FIGS. 3 and 4, a computational study was performed to study the cooling power of a composite material 10 in one embodiment composed of an aluminum-silver-silica (SiO₂) combination. The computational study of composite material 10 (shown by line 24), yielded a cooling potential of approximately 113 W/m² at an ambient temperature of approximately 300° K when exposed to direct sunlight. The computational study also analyzed an aluminum-silica combination, shown by line 26, and yielded a cooling potential of approximately 82 W/m² at an ambient temperature of approximately 300° K when exposed to direct sunlight. For the ideal case, the computational study assumed a fictional ideal material that is purely reflective in all bands other than 8-13 microns. In the 8-13 micron band, the ideal material is purely emitting (i.e., emissivity=1). As shown, the aluminum-silver-silica combination outperforms the ideal case, shown by line 28, above an ambient temperature of approximately 310° K due to a broader emission spectrum above approximately 13 μm thereby accessing narrower atmospheric window bands in the 20 to 25 micron range.

As shown in FIG. 4, the computational study of the aluminum-silver-silica combination, shown by line 30, yields a cooling potential exceeding approximately 250 W/m² when exposed to the nighttime sky and outperforms the ideal case, line 32, above an ambient nighttime temperature of 255° K. It will therefore be appreciated that the composite material 10 includes at least one thermally-emissive layer 14 bonded to a base layer 12, via a binding agent 20, where the composite material 10 produces a positive cooling potential in both daytime and nighttime ambient temperatures.

In still other embodiments, compositions of the present invention may be applied to fabric where passive cooling may be beneficially applied, such to as a tent, awning or even an article of clothing.

In yet another embodiment, the compositions of the present invention may be included in sunscreen formulation in a base or carrier material otherwise suitable to topical applications, as are known and used in the art. Such sunscreen formulation embodiments may include a suspension of the plurality of microparticles in a base other than a transparent polymer.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1-52. (canceled)

53. A method of providing a composite material for passive radiative cooling to a roof surface, said method comprising:
applying to said roof surface a liquid suspension of microparticles in a liquid binding agent and
curing said binding agent so as to form a thermally-emissive layer on said roof surface, whereby said thermally-emissive layer is affixed to said roof surface via said binding agent.

54. The method of claim 53, wherein said object comprises a base layer to which said liquid suspension is applied, said base layer comprising a reflective substrate.

55. The method of claim 54, wherein said reflective substrate is composed of at least one of aluminum, silver, glass, polyurethane, nylon, and polyethylene fibers.

56. The method of claim 54, wherein said reflective substrate comprises paint.

57. The method of claim 53, wherein said binding agent is composed of a polymer material.

58. The method of claim 53, wherein said binding agent is transparent.

59. The method of claim 53, wherein said binding agent includes a characteristic thickness less than or equal to approximately 50 μm.

60. The method of claim 53, wherein said at least one emissive layer is composed of silica material.

61. The method of claim 53, wherein said at least one emissive layer comprises a plurality of microparticles.

62. The method of claim 61, wherein each of said plurality of microparticles is composed of silica material.

63. The method of claim 61, wherein each of said plurality of microparticles includes a characteristic dimension between about 5 to about 50 μm.

64. The method of claim 61, wherein each of said plurality of microparticles includes a characteristic dimension less than or equal to 30 μm.

65. The method of claim 53, wherein said liquid suspension is applied in the form of a spray.

66. A liquid suspension composition adapted to form a passive radiative cooling coating on a surface, said composition comprising:
a liquid suspension of microparticles in a liquid binding agent, said binding agent adapted to be disposed upon a surface and cured so as to form a thermally-emissive layer on said surface, whereby said thermally-emissive layer is affixed to said surface via said binding agent.

67. The method of claim 66, wherein said binding agent is composed of a polymer material.

68. The method of claim 66, wherein said binding agent is transparent.

69. The method of claim 66, wherein said microparticles are composed of silica material.

70. The method of claim 69, wherein each of said plurality of microparticles includes a characteristic dimension between about 5 to about 50 μm.

71. The method of claim 69, wherein each of said plurality of microparticles includes a characteristic dimension less than or equal to 30 μm.

72. The method of claim 66, wherein said liquid suspension is of sufficiently reduced viscosity to be applied to a surface in the form of a spray.

73. A liquid suspension composition adapted to form a passive radiative cooling coating on a surface, said composition comprising:
a liquid suspension of a microparticles composed of silica material in a liquid binding agent composed of a transparent polymer material, said binding agent adapted to be disposed upon a surface and cured so as to form a thermally-emissive layer on said surface, whereby said thermally-emissive layer is affixed to said surface via said binding agent.

74. The method of claim 73, wherein each of said plurality of microparticles includes a characteristic dimension between about 5 to about 50 μm.

75. The method of claim 73, wherein each of said plurality of microparticles includes a characteristic dimension less than or equal to 30 μm.

76. The method of claim 73, wherein said liquid suspension is of sufficiently reduced viscosity to be applied to a surface in the form of a spray.
